(19) United States
(12) Patent Application Publication
(10) Pub. No.: US 2007/0074241 A1
(43) Pub. Date: Mar. 29, 2007

(54) Digital video receiver and display method thereof

(75) Inventor: Chang Hoon Yeo, Gyeonggi-do (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/501,044

(22) Filed: Aug. 9, 2006

(30) Foreign Application Priority Data
Sep. 28, 2005 (KR) 10-2005-0090677

(51) Int. Cl. H04N 7/167

(52) U.S. Cl. 725/31

(57) ABSTRACT

Disclosed herein are a digital video receiver which supports a High Definition Multimedia Interface (HDMI) standard, and a display method thereof. The digital video receiver includes an HDMI receiver including a memory for storing HDMI information, and a High-bandwidth Digital Content Protection (HDCP) module. As such, it is possible to flexibly cope with an authentication error in an HDCP connection and very stably protect digital video contents.

This application claims the benefit of Korean Patent Application No. 10-2005-0090677, filed on Sep. 28, 2005, which is hereby incorporated by reference as if fully set forth herein.

### BACKGROUND OF THE INVENTION

1. Field of the Invention

The present invention relates to a digital video receiver which decrypts encrypted digital video data, and a display method thereof.

2. Discussion of the Related Art

Recently, standards, such as High Definition Multimedia Interface (HDMI) and Digital Visual Interface (DVI), have been employed for transmission and reception of digital video data between a digital video transmitter and a digital video receiver.

A High-bandwidth Digital Content Protection (HDCP) standard has been applied to digital video data being transmitted and received on the basis of the above standards, such that the digital video data is advantageously resistant to unauthorized duplication thereof.

In general, a display system comprises a digital video transmitter and a digital video receiver, and is adapted to receive a multimedia signal including video and audio and output the received multimedia signal in the form of an image and sound through a display unit.

In order to support the aforementioned standard (HDMI or DVI), the digital video transmitter and digital video receiver of the display system must be able to support the corresponding standard.

However, generally, the digital video receiver must have, in the form of a separate chip, a non-volatile memory which stores information regarding the display unit, which is a kind of display means, and also have an extended I²C communication module chip with two pull-up resistors to read standard information from the memory.

As a result, the general digital video receiver is disadvantageous in that it additionally has the I²C communication module chip and the memory chip, resulting in a complexity in driving circuit and an increase in cost. Further, an I²C communication path becomes complicated, thereby increasing the possibility that an error will occur during I²C communication.

In addition, the general digital video receiver has poor flexibility for an error in an HDCP connection and protection of digital contents.

### SUMMARY OF THE INVENTION

Accordingly, the present invention is directed to a digital video receiver and a display method thereof that substantially obviate one or more problems due to limitations and disadvantages of the related art.

An object of the present invention is to provide a digital video receiver which has a simple structure to realize excellent flexibility for an error in an HDCP connection and protection of digital contents, and a display method thereof.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a digital video receiver comprises: a display unit; a display controller for providing video data to the display unit; and a High Definition Multimedia Interface (HDMI) receiver including a memory for storing HDMI information, and a High-bandwidth Digital Content Protection (HDCP) module.

The HDMI information may include extended display identification data (EDID) information, and an HDCP authentication key, which may be encrypted when being stored in the memory.

The HDMI receiver may further include: an information detector for detecting the information stored in the memory; and an information updater for changing the information stored in the memory, and the HDCP module may comprise: a public key creator for reading and decrypting the encrypted HDCP authentication key stored in the memory to create a public key; and a decrypter for decrypting inputted digital video data using the created public key.

The HDCP module may further comprise a user encryption key setter for setting a user encryption key using the created public key according to a user's setting, and a scheme for decrypting the authentication key by the public key creator may be re-set by changing the user encryption key.

The display controller may comprise: an error detector for detecting an authentication error of the HDCP module; and a command sender for sending a pause signal or pause release signal to the display unit, and the memory may be a non-volatile memory (NVM).

In another aspect of the present invention, a display method of a digital video receiver comprises: (a) performing an HDCP authentication to decrypt inputted digital video data; (b) periodically checking presence/absence of an error in an HDCP connection; and (c) displaying the decrypted digital video data.

The step (a) may comprise: reading and decrypting an HDCP authentication key to create a public key; decrypting the inputted video data using the created public key; and setting a user encryption key using the created public key according to a user's setting.

The step (b) may comprise: determining whether the error in the HDCP connection is present in the digital video receiver; and sending a pause signal if it is determined that the error in the HDCP connection is present in the digital video receiver, and the error may include an error in the HDCP authentication.

The step (c) may comprise pausing or normally displaying the decrypted digital video data in response to a command signal sent at the step (b).

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram showing the configuration of a display system with a digital video receiver according to one embodiment of the present invention;

FIG. 2 is a block diagram of an HDMI-receiver in FIG. 1;

FIG. 3 is a block diagram of an HDCP module in FIG. 2;

FIG. 4 is a flowchart illustrating a display method of the digital video receiver according to one embodiment of the present invention; and

FIG. 5 is a flowchart illustrating the step of decrypting digital video data in FIG. 4.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

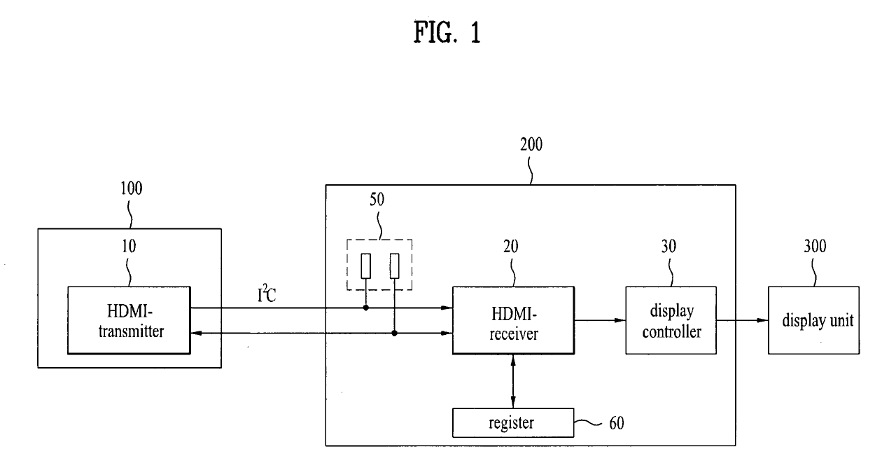

FIG. 1 is a block diagram showing the configuration of a display system with a digital video receiver according to one embodiment of the present invention.

As shown in FIG. 1, the display system comprises a digital video transmitter 100 including an HDMI-transmitter 10 for providing encrypted digital video data, a digital video receiver 200 including an HDMI-receiver 20 for decrypting the digital video data received from the digital video transmitter 100, and a display unit 300 for outputting the digital video data decrypted by the digital video receiver 200. The digital video transmitter 100 and the digital video receiver 200 are interconnected via an I²C bus based on a serial protocol, such as I²C.

In an HDCP standard, the HDMI-transmitter 10, which transmits the digital video data, and the HDMI-receiver 20, which receives the digital video data, authenticate each other using a public key encryption scheme, and the HDMI-transmitter 10 then encrypts and transmits the digital video data to the HDMI-receiver 20.

For the authentication and encryption, the digital video transmitter 100 and the digital video receiver 200 share their respective public keys with each other. A private key concealed in each of them is called a device key.

Accordingly, if the authentication is successful between the digital video transmitter 100 and the digital video receiver 200, the digital video transmitter 100 encrypts and transmits the digital video data using its device key, and the digital video receiver 200 receives and decrypts the digital video data using its device key. Then, the display unit 300 outputs the decrypted digital video data through a screen or speaker.

Optionally, using a created public key, the user may set encryption and store a user encryption key. In this case, the user encryption key may be stored in an allocated area of a register 60 or an internal memory of the HDMI-receiver 20.

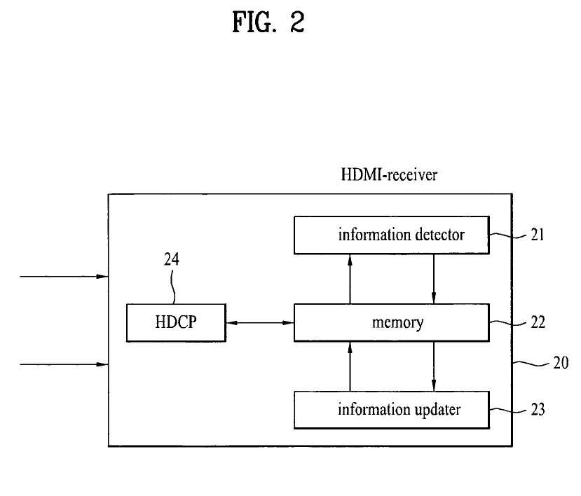

FIG. 2 is a block diagram of the HDMI-receiver 20 in FIG. 1.

As shown in FIG. 2, the HDMI-receiver 20 includes an information detector 21, a memory 22, and an information updater 23.

The HDMI-receiver 20 further includes an HDCP module 24 for performing the HDCP authentication as stated above. The memory 22 is a non-volatile memory, which may be any one of a flash memory or electrically erasable programmable read only memory (EEPROM).

The HDCP module 24 performs the encryption authentication in communication with the HDMI-transmitter 10, as stated previously.

The memory 22 of the HDMI-receiver 20 stores information indicative of HDMI supportability/nonsupportability of the display unit 300, which is incorporated in the digital video receiver 200 or externally connected thereto.

The HDMI-transmitter 10 reads the information indicative of the HDMI supportability/nonsupportability of the display unit 300 from the memory 22 of the HDMI-receiver 20 and determines from the read information whether the display unit 300 supports an HDMI standard.

The information detector 21 functions to, when the HDMI-transmitter 10 reads information from the HDMI-receiver 20, detect that information (for example, the information indicative of the HDMI supportability/nonsupportability of the display unit 300) from the memory 22.

In more detail, as stated above, the reading of information from the memory 22 of the HDMI-receiver 20 by the HDMI-transmitter 10 is carried out through communication between the HDMI-transmitter 10 and the HDMI-receiver 20.

That is, in the present embodiment, the HDMI-receiver 20 notifies the HDMI-transmitter 10 of the HDMI supportability/nonsupportability of the display unit 300 in communication with the HDMI-transmitter 10. At this time, the information detector 21 of the HDMI-receiver 20 detects the information indicative of the HDMI supportability/nonsupportability of the display unit 300 from the memory 22 in response to a request from the HDMI-transmitter 10. The information detector 21 then transmits the detected information to the HDMI-transmitter 10.

Here, the HDMI-receiver 20 transmits extended display identification data (EDID) to the HDMI-transmitter 10 using a signal protocol proposed in an EDID standard.

Also, the aforementioned encryption authentication is carried out through communication between the HDMI-transmitter 10 and the HDCP module 24 included in the HDMI-receiver 20.

At this time, the information detector 21 of the HDMI-receiver 20 detects an encryption authentication key stored in the memory 22. Then, the encryption authentication is performed using the detected authentication key.

Meanwhile, the information updater 23 included in the HDMI-receiver 20 is operated for change of data stored in the memory 22. Here, the data stored in the memory 22 is the information indicative of the HDMI supportability/nonsupportability and/or encryption authentication key.

The information updater 23 is operated under an external control (for example, a control applied by an operation of a manufacturer of a digital video player).

According to the present embodiment, the display system with the digital video receiver 200 adopts an Inter Integrated Circuit (I²C) bus for I²C communication between the HDMI-transmitter 10 and the HDMI-receiver 20. The I²C bus consists of two communication lines to support communication of two types of signals between the HDMI-transmitter 10 and the HDMI-receiver 20.

An I²C communication module chip including two pull-up resistors 50 is used for the I²C communication between the HDMI-transmitter 10 and the HDMI-receiver 20.

In the above-described configuration according to the present embodiment, the HDMI-transmitter 10 reads information (the information indicative of the HDMI supportability/nonsupportability) regarding the display unit 300 from the HDMI-receiver 20 through the I²C communication therewith and determines from the read information whether the display unit 300 supports the HDMI standard.

On the other hand, the aforementioned information indicative of the HDMI supportability/nonsupportability is extended display identification data (EDID). The encryption authentication key is encrypted when being stored in the memory 22, such that the encryption authentication key stored in the memory 22 does not flow out of the memory 22 in the process of reading or writing the EDID from/into the memory 22 by the information detector 21 or information updater 23.

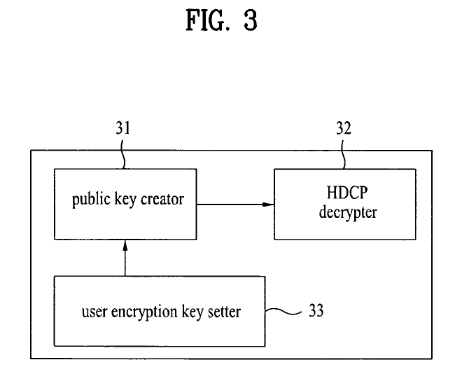

FIG. 3 is a block diagram of the HDCP module 24 in FIG. 2.

As shown in FIG. 3, the HDCP module 24 includes a public key creator 31 for reading and decrypting the encrypted authentication key from the memory 22 to create a public key, an HDCP decrypter 32 for decrypting an inputted digital signal using the created public key, and a user encryption key setter 33 for setting a user encryption key using the created public key.

The user encryption key setter 33 acts to set the user encryption key using the created public key of the authentication key so that the user can optionally set encryption. The public key creator 31 acts to decrypt the authentication key using the user encryption key set by the user encryption key setter 33.

Moreover, a scheme for decrypting the authentication key by the public key creator 31 can be re-set by changing the user encryption key.

At this time, the optionally set user encryption key can be stored in the memory 22 included in the HDMI-receiver 20 or an allocated area of the register 60.

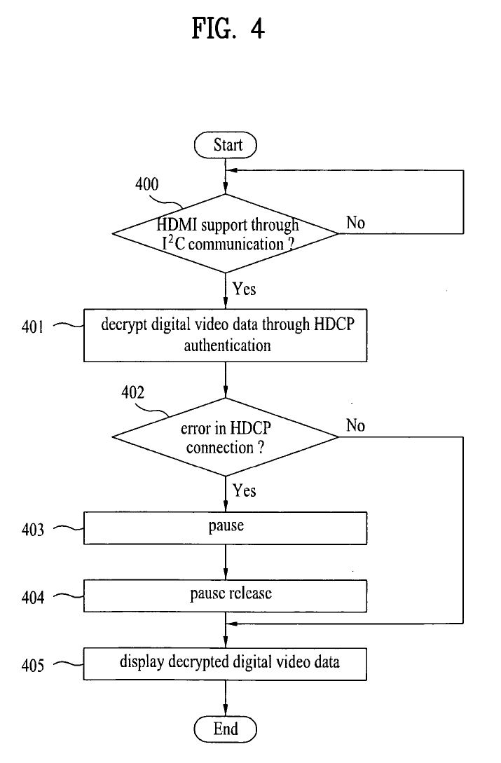

FIG. 4 is a flowchart illustrating a display method of the digital video receiver 200 according to one embodiment of the present invention.

First, the HDMI-transmitter 10 in the digital video transmitter 100 determines whether the HDMI-receiver 20 in the digital video receiver 200 supports the HDMI standard, through the I²C communication with the HDMI-receiver 20 (400).

If the HDMI-transmitter 10 determines that the HDMI-receiver 20 supports the HDMI standard, the HDMI-receiver 20 decrypts digital video data inputted to the digital video receiver 200 through the HDCP authentication (401).

Then, a display controller 30 included in the digital video receiver 200 periodically checks the presence/absence of an authentication error in an HDCP connection at an interval of about two seconds (402). If no authentication error is present, the display controller 30 proceeds directly to step 405 of displaying the decrypted digital video data. If an authentication error is present, the display controller 30 sends a pause command signal to pause at the current state (403).

Here, the checking of the presence/absence of an authentication error includes checking the presence/absence of a hot plug detection (HPD) signal.

Next, if the user recognizes the pause state and then inputs a pause release command, the display controller 30 releases the pause state (404) and then displays the decrypted digital video data through the display unit 300 (405).

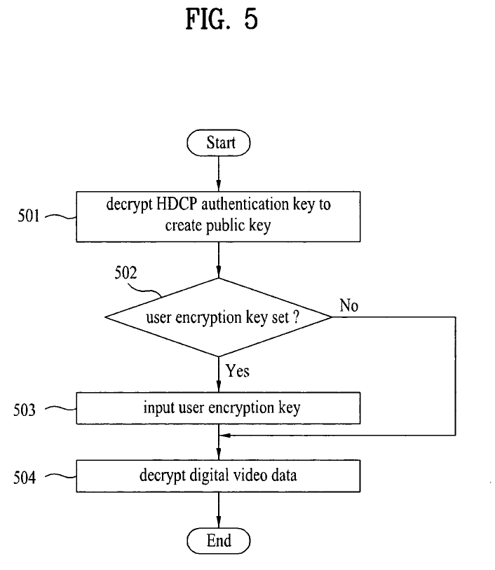

FIG. 5 is a flowchart illustrating step 401 of decrypting digital video data in FIG. 4.

First, a public key is created by reading and decrypting an HDCP authentication key (501). As stated previously with reference to FIG. 1, for the authentication and encryption, the digital video transmitter 100 and the digital video receiver 200 share their respective public keys with each other. A private key concealed in each of them is called a device key.

Meanwhile, the user may optionally set a user encryption key using the created public key. For this reason, after the above step 501 is performed, a determination is made as to whether a user encryption key has been set (502) before the inputted digital video data is decrypted using the created public key (504). If it is determined that a user encryption key has been set, the set user encryption key is inputted (503). If it is determined that no user encryption key has been set, the inputted digital video data is decrypted (504) and then outputted to the display unit 300.

Here, the user encryption key may be stored in an allocated area of the register 60 included in the digital video receiver 200 or the memory 22 included in the HDMI-receiver 20.

Although the interface between the digital video transmitter 100 and the digital video receiver 200 has been disclosed in the present embodiment to be the HDMI, it may be a digital visual interface (DVI).

As apparent from the above description, according to the present invention, the information (EDID) indicative of the HDMI supportability/nonsupportability of the digital video receiver is stored in the memory included in the HDMI-receiver without using an additional I²C communication module chip or memory, thereby making it possible to simplify a driving circuit of the digital video receiver.

In addition, it is possible to curtail the manufacturing cost of the digital video receiver and significantly reduce the possibility that an error will occur during I²C communication between the digital video transmitter and the digital video receiver.

Furthermore, it is possible to flexibly cope with an authentication error in an HDCP connection and very stably protect digital video contents.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A digital video receiver comprising:
a display unit;
a display controller for providing video data to the display unit; and
a High Definition Multimedia Interface (HDMI) receiver including a memory for storing HDMI information, and a High-bandwidth Digital Content Protection (HDCP) module.

2. The digital video receiver according to claim 1, wherein the HDMI information includes extended display identification data (EDID) information.

3. The digital video receiver according to claim 1, wherein the HDMI information includes an HDCP authentication key.

4. The digital video receiver according to claim 3, wherein the HDCP authentication key is encrypted when being stored in the memory.

5. The digital video receiver according to claim 1, wherein the HDMI receiver further includes:
an information detector for detecting the information stored in the memory; and
an information updater for changing the information stored in the memory.

6. The digital video receiver according to claim 4, wherein the HDCP module comprises:
a public key creator for reading and decrypting the encrypted HDCP authentication key stored in the memory to create a public key; and
a decrypter for decrypting inputted digital video data using the created public key.

7. The digital video receiver according to claim 6, wherein the HDCP module further comprises a user encryption key setter for setting a user encryption key using the created public key according to a user's setting.

8. The digital video receiver according to claim 7, wherein a scheme for decrypting the authentication key by the public key creator is re-set by changing the user encryption key.

9. The digital video receiver according to claim 1, wherein the display controller comprises:
an error detector for detecting an authentication error of the HDCP module; and
a command sender for sending a pause signal or pause release signal to the display unit.

10. A display method of a digital video receiver comprising:
(a) performing an HDCP authentication to decrypt inputted digital video data;
(b) periodically checking presence/absence of an error in an HDCP connection; and
(c) displaying the decrypted digital video data.

11. The display method according to claim 10, wherein the step (a) comprises:
reading and decrypting an HDCP authentication key to create a public key; and
decrypting the inputted video data using the created public key.

12. The display method according to claim 11, wherein the step (a) further comprises setting a user encryption key using the created public key according to a user's setting.

13. The display method according to claim 10, wherein the step (b) comprises:
determining whether the error in the HDCP connection is present in the digital video receiver; and
sending a pause signal if it is determined that the error in the HDCP connection is present in the digital video receiver.

14. The display method according to claim 13, wherein the error includes an error in the HDCP authentication.

15. The display method according to claim 10, wherein the step (c) comprises pausing or normally displaying the decrypted digital video data in response to a command signal sent at the step (b).
